(19) United States
(12) Patent Application Publication
(10) Pub. No.: US 2007/0072779 A1
(43) Pub. Date: Mar. 29, 2007

(54) Low dust-generating grease composition and direct acting guide device containing the same

(75) Inventors: Shinichi Nagahora, Fujisawa-shi (JP); Hidekazu Michioka, Tokyo (JP); Yoshihiro Hirano, Naka Koma-gun (JP); Hiroyuki Ikeda, Naka Koma-gun (JP); Yoshio Taki, Naka Koma-gun (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: THK CO., LTD., Tokyo (JP)

(21) Appl. No.: 11/526,214

(22) Filed: Sep. 25, 2006

Related U.S. Application Data
(63) Continuation of application No. PCT/JP05/05344, filed on Mar. 24, 2005.

(30) Foreign Application Priority Data
Mar. 26, 2004 (JP) 2004-091565

(51) Int. Cl. C08F 8/34

(52) U.S. Cl. 508/548

(57) ABSTRACT

The present invention herein provides a grease composition for use in a direct acting guide apparatus, which comprises a base oil and a thickener, wherein the rate of an ester oil present in the base oil is not less than 50% by mass, the composition comprises not less than 20% by mass of the thickener which comprises a compound having a terminal aliphatic hydrocarbon group and free of metal and it has a penetration ranging from 220 to 300, as well as a direct acting guide apparatus which comprises the foregoing grease composition. The grease composition of the present invention has various excellent characteristic properties such that it generates only a small quantity of dust, that the production cost thereof is low, that the composition is free of metallic component and that it is free of bad roll feeling.

### TECHNICAL FIELD

The present invention relates to a grease composition and in particular, to a low dust-generating grease composition suitable for use in a lubrication part to be incorporated into a direct acting guide device which is used in a clean environment.

### BACKGROUND ART

It is required that a lubricating composition used in a lubrication part to be incorporated into a device which is used in a clean environment, such as a semiconductor-manufacturing device, a liquid crystal-production device, a computer and a printed board-making device, does not cause contamination of peripheral machinery and tools and products prepared by these devices even when the composition is accidentally scattered. In particular, in a direct acting device (such as a direct acting guide, a ball screw or a direct acting ball bearing) among the lubrication devices, the lubricated plane thereof is exposed to the exterior and therefore, such a direct acting device is liable to cause contamination of the environment in which it is used, through the scattering of the composition included therein, as compared with sealed or enclosed type bearing and a lubricant used therein is required to be excellent, in particular, in the low dust-generation characteristics. In addition, such a lubricant is also required to be free of any metallic component so that, even when it is scattered and adhered to a resulting product, it does not any effect on electrification of the resulting product.

As the grease used in such portions which should satisfy the foregoing requirements, there have conventionally been known a fluorine grease (see, for instance, Patent Document 1 specified below) and an ether type base oil based urea grease (see, for instance, Patent Document Nos. 2 and 3 specified below).

When comparing these greases with those for general use, which must not necessarily satisfy the requirement for low dust-generation characteristics, however, the fluorine grease suffers from various problems in that it requires a high production cost, that the grease generates high torque and that it becomes difficult to handle the same. On the other hand, the ether type base oil based urea grease suffers from such a problem that it leads to an increase in rolling resistance (hereafter referred to as so-called “bad roll feeling” and accordingly, the grease satisfies the requirement for low dust-generation characteristics at the sacrifice of other characteristic properties.

In addition, as the low dust-generating grease which can deal with such a problem of rolling resistance, there has been known one comprising lithium stearate as a thickener (see, for instance, Patent Document 4 specified below). However, since this grease comprises metal elements, the metal elements may transfer into products to make them defective, if the grease is used in a direct acting guide device employed in, for instance, a semiconductor-manufacturing device.

For the reasons above, there has been desired for the development of a low dust-generating grease which can show low dust-generation characteristics identical to those observed for the conventional low dust-generating grease, whose production cost is low, which is free of metallic component and which is free of bad roll feeling.
Patent Document 1: JP-A-Hei 6-229426;
Patent Document 2: JP-A-2000-192973;
Patent Document 3: JP-A-2001-139975;
Patent Document 4: JP-A-Hei 11-166191.

### DISCLOSURE OF THE INVENTION

### Problems to be Solved by the Invention

It is an object of the present invention to provide a low dust-generating grease composition and, in particular, a low dust-generating grease composition, whose production cost is low, which is free of metallic component and which is free of bad roll feeling.

It is another object of the present invention to provide a low dust-generating grease composition, whose dust-generating ability is not more than 100 particles/L, whose rolling resistance is not more than 25N and which is free of metallic component.

It is a still another object of the present invention to provide a direct acting guide device containing the foregoing grease composition incorporated into the same.

Means for Solving the Problems

According to the present invention, there are provided the following low dust-generating grease compositions:
1. A grease composition for use in a direct acting guide apparatus, which comprises a base oil and a thickener, wherein the rate of an ester oil present in the base oil is not less than 50% by mass, the composition comprises not less than 20% by mass of the thickener which comprises a compound having a terminal aliphatic hydrocarbon group and free of metal and the composition has a penetration ranging from 220 to 300.
2. The grease composition as set forth in the foregoing item 1, wherein the compound having a terminal aliphatic hydrocarbon group and free of metal is an aliphatic diurea compound.
3. The grease composition as set forth in the foregoing item 2, wherein the diurea compound having a terminal aliphatic hydrocarbon group is one represented by the following general formula:
   R¹NHCONHR²NHCONHR³
   wherein R¹ and R³ may be the same or different and each represents an aliphatic hydrocarbon group having 12 to 24 carbon atoms; and R² represents a divalent aromatic hydrocarbon group having 6 to 13 carbon atoms.
4. The grease composition as set forth in any one of the foregoing items 1 to 3,
   wherein the ester oil is one selected from the group consisting of those represented by the following general formulas:
(1) Diester type synthetic oils represented by the formula:
   R⁴OCO(CH₂)ₙCOOR⁵
   wherein R⁴ and R⁵ may be the same or different and each represents an aliphatic hydrocarbon group having 3 to 18 carbon atoms; and n represents a number ranging from 3 to 12;
(2) Triester type synthetic oils represented by the formula:
   C₂H₅C(CH₂OCOR⁶)₃
   wherein R⁶ may be the same or different and each represents an aliphatic hydrocarbon group having 3 to 10 carbon atoms;
(3) Tetraester type synthetic oils represented by the formula:
   C(CH₂OCOR⁷)₄
   wherein R⁷ may be the same or different and each represents an aliphatic hydrocarbon group having 3 to 10 carbon atoms;
(4) Dipentaerythritol type synthetic oils represented by the formula:
   C(CH₂OC—OR⁸)₃C₂H₅OC₂H₅C(CH₂OCOR⁸)₃
   wherein R⁸ may be the same or different and each represents an aliphatic hydrocarbon group having 3 to 10 carbon atoms; and
(5) Other neopentyl polyol ester type synthetic oils.
5. The grease composition as set forth in any one of the foregoing items 1 to 4,
   wherein the direct acting guide apparatus is a direct acting guide, a ball screw, a direct acting ball bearing, or a ball spline.
6. A direct acting guide device comprising a grease composition as set forth in any one of the foregoing items 1 to 5.

### EFFECTS OF THE INVENTION

The low dust-generating grease of the present invention generates only a small quantity of dust and possesses a low rolling resistance. Moreover, the production cost thereof is low, the composition is free of metallic component and it is free of bad roll feeling.

### BEST MODE FOR CARRYING OUT THE INVENTION

The base oil used in the invention comprises an ester oil in an amount of not less than 50% by mass, preferably not less than 60% by mass and more preferably not less than 80% by mass. In this respect, if the rate of the ester oil is less than 50% by mass, the resulting grease composition becomes harder and has a penetration of higher than 220 even when the amount of the thickener is 20% by mass. For this reason, the amount of the thickener should be reduced to a level of not more than 20% by mass in order to obtain a grease composition having a penetration falling within the range of from 220 to 300. This leads to an increase m the amount of dust generated.

The ester oil is preferably aliphatic hydrocarbon type one. Particularly preferably used herein is at least one member selected from the group consisting of those represented by the general formulas (1) to (5) specified above.

Specific examples of the diester type synthetic oils represented by the formula (1) include di-2-ethylhexyl sebacate, di-2-ethylhexyl azelate and di-2-ethylhexyl adipate; specific examples of the triester type synthetic oils represented by the formula (2) include trimethylolpropane carboxylic acid esters; specific examples of the tetraester type synthetic oils represented by the formula (3) include pentaerythritol carboxylic acid esters; specific examples of the dipentaerythritol type synthetic oils represented by the formula (4) are dipentaerythritol carboxylic acid esters; and specific examples of the other neopentyl polyol ester type synthetic oils represented by the formula (5) are neopentyl polyol carboxylic acid esters.

The kinetic viscosity, as determined at a temperature of 40° C., of the base oil used in the grease composition of the present invention preferably ranges from 20 to 500 mm²/s and more preferably 50 to 200 mm²/s.

The diurea compound having a terminal aliphatic hydrocarbon group used in the invention as a thickener is preferably one represented by the following general formula: R¹NHCONHR²NHCONHR³ wherein R¹ and R³ may be the same or different and each represents an aliphatic hydrocarbon group having 12 to 24 carbon atoms; and R² represents a divalent aromatic hydrocarbon group having 6 to 13 carbon atoms. Such a diurea compound can easily be prepared by the reaction of an aromatic diisocyanate with an aliphatic monoamine. Examples of such aromatic diisocyanates are phenylene diisocyanate, diphenyl diisocyanate, phenyl diisocyanate, diphenylmethane-4,4′-diisocyanate, tolylene diisocyanate, naphthalene diisocyanate, and toluidine diisocyanate. Among them, diphenylmethane-4,4′-diisocyanate and tolylene diisocyanate have commonly used in the world and the use thereof is advantageous from the viewpoint of the production cost.

Examples of aliphatic monoamines are those having 12 to 24 carbon atoms such as dodecylamine, tetradecylamine, hexadecylamine, octadecylamine and behenylamine.

Regarding the compound, which has a terminal aliphatic hydrocarbon group and which is free of metal, used in the grease composition of the present invention as a thickener, the amount of the compound is preferably not less than 20% by mass and more preferably not less than 25% by mass. The upper limit of the amount of the compound is one wherein the resulting grease composition has a penetration of not less than 220. It is advantageous that the hardness of the grease is high for the purpose of reducing dust generation, but if the penetration is less than 220, the resulting grease composition is insufficient in fluidity and penetrability and it cannot ensure lubrication characteristics essential thereto. If using the compound, as a thickener, which has a terminal aliphatic hydrocarbon group and which is free of metal, in the grease composition in an amount of less than 20% by mass, the amount of dust generated during use increases and accordingly, the resulting grease composition cannot always show any intended effect of the present invention.

Regarding the relative amounts of the base oil and the compound, which has a terminal aliphatic hydrocarbon group and which is free of metal, present in the grease composition of the present invention, it is preferred that the amount of the base oil falls within the range of from 60 to 80% by mass, while that of the compound used as a thickener ranges from 20 to 40% by mass.

Various kinds of additives may, if necessary, be incorporated into the grease composition of the present invention. Examples of such additives include an antioxidant (such as an amine type antioxidant), a rust-proofing agent (such as succinate rust-proofing agent), a metal corrosion-preventing agent, an oiliness improver, a wear-resistant agent, an extreme pressure agent and a solid lubricant, but preferably used herein are those free of metallic component.

The grease composition of the present invention can easily be prepared by mixing the foregoing components and optional other additives in a desired mixing ratio.

The grease composition of the present invention is suitable for use in direct acting devices, in particular, a direct acting guide device such as a direct acting guide, a ball screw, a direct acting ball bearing and a ball spline.

### EXAMPLES AND COMPARATIVE EXAMPLES

A variety of grease compositions were prepared using diurea compounds listed in Table 1, as the thickeners and oils obtained by mixing components listed in Table 1 in a rate specified in Table 1, as base oils.

The quantity of dust generated is determined by counting the number of particles having a particle size of not less than 0.3 μm and generated by a direct acting guide (SR20w1+280 LP available from THK Co., Ltd.) when the direct acting guide is operated at an amplitude of 200 mm and a maximum speed of 30 m/min over 50 hours using a particle counter (KC-01D available from RION Co., Ltd.). In addition, the grease was simply used, in each experiment, in an initially charged and sealed amount equal to 1 cm³ per one block.

Bad roll feeling is evaluated on the basis of the rolling resistance observed for fine strokes during operating a direct acting guide (HSR35R1UUC0+440LSP available from THK Co., Ltd.) at an amplitude of 3 mm, a feed rate of 1 mm/sec, a stopping time of 0.1 sec and a time constant of 7 ms (0.01 G) over 60 minutes. Further, the grease was simply used, in each experiment, in an initially charged and sealed amount equal to 4 cm³.

Evaluation Criteria:

TABLE 1

| | Example | | | | Comp. Example | | |
|---|---|---|---|---|---|---|---|
| | 1 | 2 | 3 | 4 | 1 | 2 | 3 |
| Base oil | 71.6 | 72.0 | 72.5 | 71.7 | 75.5 | 81.5 | 80.2 |
| Ester | (80) | (100) | (100) | (60) | | | (60) |
| PAO | (20) | | | | | (100) | (40) |
| Ether | | | | (40) | (100) | | |
| Kinetic Viscosity | 99 | 170 | 45 | 112 | 103 | 100 | 94 |
| (40° C.) | | | | | | | |
| Thickener | | | | | | | |
| Aliphatic diurea | 26.9 | 26.5 | 26.0 | 26.8 | | 17.0 | 18.3 |
| Aromatic diurea | | | | | 23.0 | | |
| Antioxidant | 1.0 | 1.0 | 1.0 | 1.0 | 1.0 | 1.0 | 1.0 |
| Rust-Proofing Agent | 0.5 | 0.5 | 0.5 | 0.5 | 0.5 | 0.5 | 0.5 |
| Penetration | 260 | 255 | 273 | 266 | 280 | 254 | 313 |
| Amt. of Dust | 70 | 70 | 80 | 90 | 100 | 960 | 370 |
| (particle/L) | | | | | | | |
| Rolling Resistance | ◯ | ◯ | ◯ | ◯ | X | ◯ | ◯ |

Ester: Dipentaerythritol carboxylic acid ester oil;
PAO: Poly(α-olefin) oil;
Ether: Alkyl diphenyl ether oil;
Aliphatic diurea: Diurea compound prepared by a reaction between diphenyhnethane-4,4′-diisocyanate and octadecylamine;
Aromatic diurea: Diurea compound prepared by a reaction between tolylenediisocyanate and aniline;
Antioxidant: Amine type antioxidant;
Rust-proofing agent: Succinate rust-proofing agent.
◯: A sample has a rolling resistance of less than 25N;
Δ: A sample has a rolling resistance of less than 50N;
X: A sample has a rolling resistance of not less than 50N.

### Industrial Applicability

The grease composition of the present invention is one in which the rate of an ester oil present in the base oil is not less than 50% by mass, which comprises not less than 20% by mass of a thickener comprising a compound having a terminal aliphatic hydrocarbon group and free of metal and which has a penetration ranging from 220 to 300. Accordingly, the grease composition of the present invention has various excellent characteristic properties such that it generates only a small quantity of dust, that the production cost thereof is low, that the composition is free of metallic component and that it is free of bad roll feeling. Therefore, the grease composition of the present invention is suitable as a grease composition used, in particular, in a direct acting guide device such as a direct acting guide, a ball screw, a direct acting ball bearing and a ball spline.

What is claimed is:

1. A grease composition for use in a direct acting guide apparatus, which comprises a base oil and a thickener, wherein the rate of an ester oil present in the base oil is not less than 50% by mass, the composition comprises not less than 20% by mass of the thickener which comprises a compound having a terminal aliphatic hydrocarbon group and free of metal and the composition has a penetration ranging from 220 to 300.

2. The grease composition as set forth in claim 1, wherein the compound having a terminal aliphatic hydrocarbon group and free of metal is an aliphatic diurea compound.

3. The grease composition as set forth in claim 2, wherein the diurea compound having a terminal aliphatic hydrocarbon group is one represented by the following general formula:
R¹NHCONHR²NHCONHR³
wherein R¹ and R³ may be the same or different and each represents an aliphatic hydrocarbon group having 12 to 24 carbon atoms; and R² represents a divalent aromatic hydrocarbon group having 6 to 13 carbon atoms.

4. The grease composition as set forth in claim 1, wherein the ester oil is one selected from the group consisting of those represented by the following general formulas:
(1) Diester type synthetic oils represented by the formula:
R⁴OCO(CH²)ₙCOOR⁵
wherein R⁴ and R⁵ may be the same or different and each represents an aliphatic hydrocarbon group having 3 to 18 carbon atoms; and n represents a number ranging from 3 to 12;
(2) Triester type synthetic oils represented by the formula:
C₂H₅C(CH₂OCOR⁶)₃
wherein R⁶ may be the same or different and each represents an aliphatic hydrocarbon group having 3 to 10 carbon atoms;
(3) Tetraester type synthetic oils represented by the formula:
C(CH₂OCOR⁷)₄
wherein R⁷ may be the same or different and each represents an aliphatic hydrocarbon group having 3 to 10 carbon atoms;
(4) Dipentaerythritol type synthetic oils represented by the formula:
C(CH₂OC—OR⁸)₃C₂H₅OC₂H₅C(CH₂OCOR⁸)₃
wherein R⁸ may be the same or different and each represents an aliphatic hydrocarbon group having 3 to 10 carbon atoms; and
(5) Other neopentyl polyol ester type synthetic oils.

5. The grease composition as set forth in claim 1, wherein the direct acting guide apparatus is a direct acting guide, a ball screw, a direct acting ball bearing, or a ball spline.

6. A direct acting guide device comprising a grease composition as set forth in any one of claims 1 to 5.
